(19) United States
(12) Patent Application Publication
(10) Pub. No.: US 2009/0045063 A1
(43) Pub. Date: Feb. 19, 2009

(54) APPARATUS AND METHOD FOR DETECTING PARTICLES AND MICROORGANISMS USING MAGNETIC FIELD

(75) Inventors: Kyoung Ho KANG, Yongin-si (KR); Jung Joo HWANG, Suwon-si (KR); Jaechan PARK, Yongin-si (KR); Yunwoo NAM, Yongin-si (KR); Junil SOHN, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/048,625

(22) Filed: Mar. 14, 2008

(30) Foreign Application Priority Data
Aug. 13, 2007 (KR) 10-2007-0081410

(51) Int. Cl. G01N 27/26; G01N 27/30

(52) U.S. Cl. 204/556; 204/403.01

(57) ABSTRACT

Disclosed are an apparatus and a method for detecting particles and microorganisms using a magnetic field. The apparatus comprises a magnetic sensor that is provided at an outside of a passage pipe and measures a magnetic field induced by fluid moving in the passage pipe; an electrode that is provided in the passage pipe so as to apply electric current having a predetermined frequency to the fluid moving in the passage pipe to measure impedance; and a signal processing unit that uses an intensity of the magnetic field measured by the magnetic sensor and the impedance measured by the electrode to determine concentrations of particles and microorganisms included in the fluid. According to an embodiment of the invention, using electrical properties of the particles or microorganisms, it is possible to quantitatively analyze and to identify the particles or microorganisms in real time, to improve a measuring accuracy and to manufacture an ultra small-scaled particle and microorganism detecting apparatus having a simple structure.

### CROSS-REFERENCE TO RELATED APPLICATIONS

This application claims all benefits of Korean Patent Application No. 2007-81410 filed on Aug. 13, 2007 in the Korean Intellectual Property Office, the disclosures of which are incorporated herein by reference.

### BACKGROUND OF THE INVENTION

1. Field of the Invention

The present invention relates to an apparatus and a method for using an Ampere's Law to sense particles or microorganisms in a liquefied solution as water in which particles or microorganisms in gasified or liquefied air are included.

2. Description of the Prior Art

In recent years, a combination tendency of the biotechnology (BT) and the nanotechnology (NT) promotes a development of hybrid nanomaterial using a biomaterial property capable of being singularly combined.

Like this, the combination of the technologies belonging to different fields creates a frontier technology. In particular, a combination of an information technology (IT), NT and BT is indispensably required. From the combination, the rapid and correct digital information of an electrochemical or optical detection method can be used to measure analog data such as a biomaterial, a reactivity of the biomaterial and the like. Recently, since a pollution level is becoming more serious day by day due to the rapid industrial development, a relative importance of a bioenvironmental industry which is a diagnosis field of the pollution level resulting from the disease causing microorganisms in the living environments will be higher.

A type of optical measurement method for measuring a concentration of the microorganisms is to detect a fluorescence of a specific wavelength emitted when the molecules (ATP, NADPH, FAD and the like) constituting microorganisms are illuminated by light of the specific wavelength. However, a related apparatus is high-priced, a structure thereof is complex and a qualitative analysis is impossible without a material that singularly reacts with the microorganisms.

In the mean time, a molecular analytical measurement method is a way such as PCR or ELISA that measures DNA/RNA or protein or a change in characteristics. However, an expert's analysis is required, the method is carried out for a long time and the structure of a related apparatus is complex.

In addition, a type of electrical measurement method as shown in FIG. 1 is to measure a change in electrical characteristics between electrodes due to the microorganisms. According to the method, a micro channel 130 and electrodes 110, 120 are used to measure a change of impedance due to the microorganisms when the microorganisms 100 pass between the electrodes.

The above electrical measurement method is to measure an electric potential difference due to negative charges of the microorganisms in the solution, in which a measuring time is long, a micro channel clogging may be caused and a shielding means is required for a reference electrode.

Therefore, according to the above methods for measuring the microorganism concentration, a structure of a measuring apparatus is complex, the apparatus cannot be easily manufactured, a long measuring time is required and a measuring accuracy is poor.

### SUMMARY OF THE INVENTION

Accordingly, the present invention has been made to solve the above problems occurring in the prior art. An object of the invention is to provide an apparatus for detecting particles and microorganisms using a magnetic field, which has a simple structure of being easily manufactured and can perform a real time measurement, improve a measuring accuracy and confirm a type of the microorganisms to be measured.

Another object of the invention is to provide a method for detecting particles and microorganisms using a magnetic field, which can perform a real time measurement of the particles and microorganisms, improve a measuring accuracy and confirm a type of the microorganisms to be measured.

In order to achieve the above objects, there is provided an apparatus for detecting particles and microorganisms using a magnetic field, which comprises a magnetic sensor that is provided at an outside of a passage pipe and measures a magnetic field induced by fluid moving in the passage pipe; an electrode that is provided in the passage pipe so as to apply electric current having a predetermined frequency to the fluid moving in the passage pipe to measure impedance; and a signal processing unit that uses an intensity of the magnetic field measured by the magnetic sensor and the impedance measured by the electrode to determine concentrations of particles and microorganisms included in the fluid.

In addition, in order to achieve the above objects, there is provided an apparatus for detecting particles and microorganisms using a magnetic field, which comprises a magnetic sensor that is provided at an outside of a passage pipe and measures a magnetic field induced as fluid including any particles or microorganisms in a predetermined concentration moves in the passage pipe; an electrode that is provided in the passage pipe so as to apply electric current having a predetermined frequency to the fluid moving in the passage pipe to measure impedance; a reference storage unit that stores values of magnetic fields for each type of particles and microorganisms to be included in the fluid; and a signal processing unit that is connected to the magnetic sensor and the electrode, calculates an intensity of a corrected magnetic field using an intensity of the magnetic field measured by the magnetic sensor and the impedance measured by the electrode and searches an intensity of the corrected magnetic field from the reference storage unit to determine a type of the particles or microorganisms included in the fluid.

In order to achieve the above objects, there is provided a method for detecting particles and microorganisms with a magnetic field, which comprises the steps of: supplying fluid into a passage pipe using a pump; measuring a magnetic field induced by the fluid moving in the passage pipe with a magnetic sensor provided at an interval from the passage pipe at an outside of the passage pipe and measuring impedance of the fluid with an electrode provided in the passage pipe; and determining concentrations of particles and microorganisms included in the fluid using an intensity of the magnetic field measured by the magnetic sensor and the impedance measured by the electrode.

According to an embodiment of the invention, using electrical properties of the particles or microorganisms, it is possible to quantitatively analyze and to identify the particles or microorganisms in real time, to improve a measuring accuracy and to manufacture an ultra small-scaled particle and microorganism detecting apparatus having a simple structure.

### BRIEF DESCRIPTION OF THE DRAWINGS

The above and other objects, features and advantages of the present invention will be more apparent from the following detailed description taken in conjunction with the accompanying drawings, in which:

FIG. 1 shows an apparatus for electrically detecting microorganisms according to the prior art;

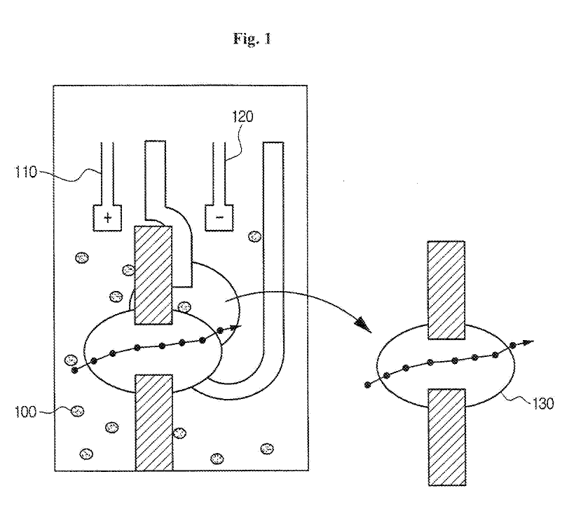

FIG. 2 shows a structure of an apparatus for detecting particles and microorganisms using a magnetic field, according to an embodiment of the invention;

FIG. 3 shows a structure of an apparatus for detecting particles and microorganisms using a magnetic field, according to another embodiment of the invention;

FIG. 4 shows a principle of operating an apparatus for detecting particles and microorganisms using a magnetic field, according to the invention; and

FIG. 5 is a flow chart showing a method for detecting particles and microorganisms using a magnetic field according to an embodiment of the invention.

### DETAILED DESCRIPTION OF THE PREFERRED EMBODIMENTS

Hereinafter, an embodiment of the present invention will be described with reference to the accompanying drawings. In the following description of the present invention, a detailed description of known functions and configurations incorporated herein will be omitted when it may make the subject matter of the present invention rather unclear.

The invention provides an apparatus and a method for measuring a magnetic field induced by a current distribution, thereby quantitatively analyzing and identifying the particles and microorganisms.

An Ampere's Law related to a linear conducting wire is expresses as follows. When current flows in a linear conducting wire, a magnetic field B generated around the conducting wire is B(r)=μ₀I/2πr according to the Ampere's Law. Therefore, the magnetic field at a distance r apart from the conducting wire is expressed by a following equation 1.

[symbol]

Bdl=μ₀I,B(2πr)=μ₀I [Equation 1]

where, λ₀=4π×10⁻⁷ (tesla·meter)/amp, which indicates permeability in vacuum. As described above, r is a distance from the conducting wire and dl indicates a displacement on an arc winding the conducting wire at a point of the distance r from the conducting wire.

That is, the magnetic field generated at a fixed distance from the linear conducting wire is directly proportional to an intensity of the current flowing in the linear conducting wire.

In the invention, the concentrations of the particles and microorganisms included in the fluid moving in the passage pipe are proportional to an amount of the charges flowing in the passage pipe. The amount of the charges corresponds to an intensity of the current flowing in the linear conducting wire. That is, in the invention, the concentrations of the particles and microorganisms included in the fluid moving in the passage pipe are proportional to an intensity of the magnetic field generated around the passage pipe.

In the followings, an embodiment of the invention will be described with reference to the drawings. However, it should be noted that the embodiment can be modified into a variety of forms and the invention is not limited to the embodiment.

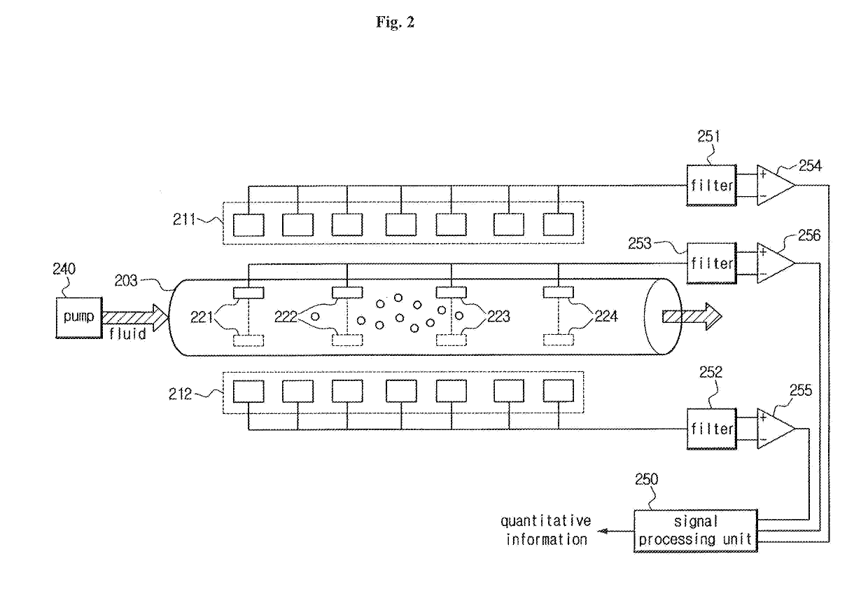

FIG. 2 shows a structure of an apparatus for detecting particles and microorganisms using a magnetic field, according to an embodiment of the invention.

Magnetic sensors 211, 212 are provided at an outside of a passage pipe 203 so as to measure a magnetic field induced by fluid moving in the passage pipe 203. The magnetic sensors 211, 212 are provided at a predetermined distance from the passage pipe 203. At this time, the distance is a value that call be arbitrarily determined by those skilled in the art. Since the invention is implemented in a MEMS size, the distance is also determined in a micro meter unit.

Although the passage pipe 203 is linearly shown in FIG. 2, the invention is not limited thereto. As required, the passage pipe 203 may be a circular or solenoid shape. When the passage pipe 203 is circular, the magnetic field B (0) at a center of the circle formed by the passage pipe 203 and the magnetic field B (R) at a distance of radius (R) of the circle formed by the passage pipe 203 are as follows.

$$B ( θ ) = \frac{{μ}_{0} I}{2 R} , B ( R ) = \frac{{μ}_{0} I}{4 \sqrt{2} R} \qquad [ equation 2 ]$$

The magnetic sensors 211, 212 may be comprised of one or more magnetic sensors. As shown in FIG. 2, a plurality of magnetic sensors may be provided at an interval at an outside of the passage pipe 203 so as to correct an error in calculating. In this case, a signal processing unit 250 uses an average of the magnetic fields received from the plural magnetic sensors as a magnetic field measured by the magnetic sensors 211, 212. The magnetic sensor includes, for example a fluxgate magnetometer, a Hall sensor, a magneto-resistance sensor and the like. The fluxgate magnetometer using two parallel ferromagnetic bodies is based on a magnet saturation circuit. The magnetic sensor is a sensor for measuring a magnitude of the magnetic field. In a broad sense, the magnetic sensor includes a magnetic head. In a narrow sense, the magnetic sensor uses an effect that various physical properties are changed due to the magnetic field. For example, there is a Hall effect that a voltage is generated when the magnetic field is applied in a direction perpendicular to the current flowing in a semiconductor, or a magneto resistance effect that an electric resistance is increased due to the magnetic field. In an intermetalic compound such as indium antimony, such effects are highly exhibited. In recent years, it is carried out a research in measuring a magnetic field in a very high sensitivity using a Josephson device. A main current of the magnetic sensor is a semiconductor magnetic sensor. The Hall effect is based which firstly introduced a complex phenomenon of magnetic-electric (current) fields. However, recently, SQUID has attracted the attention, which is referred to as a type of quantum flux modulation capable of measuring a minute magnetic field occurring in the human body. The magnetic sensor may use an electromagnetic induction effect, a magnetoelectric effect that when a magnetic field is applied to a semiconductor and the like, the electrical properties thereof are changed, a magnetic action influencing the polarization, a temperature change of the magnetic properties and the like. A Hall device, i.e., Hall sensor uses a voltage that is generated by the Hall effect when a magnetic field is applied to a material in which the current flows. However, the magneto-resistance sensor detects the voltage with a change in the flowing current, i.e., a change in the electric resistance of the material. The magnetic sensors 211, 212 output a voltage or current signal corresponding to an intensity of the magnetic field measured.

The electrodes 221˜224 are provided in the passage pipe 203 so as to apply the electric current having a predetermined frequency to the fluid moving in the passage pipe 203 to measure impedance. Here, the frequency may be arbitrarily determined. Although the electrodes 221˜224 may be comprised of a pair of electrodes, a plurality of electrodes may be provided at an interval in the passage pipe 203 so as to correct an error in measuring, as shown in FIG. 2. In this case, the signal processing unit 250 uses an average of the impedances measured by the plural electrodes as the impedance measured by the electrodes 221˜224.

A pump 240 is connected to any one inlet of the passage pipe 203 to supply the fluid in the passage pipe 203 in a predetermined rate. Here, the predetermined rate is a rate of the fluid, which can be easily determined by those skilled in the art through repeated tests. The rate of the fluid supplied by the pump 240 is determined within a range capable of minimizing the sensing time of the particles and microorganisms while generating a sufficient magnetic field to the magnetic sensors 211, 212.

The signal processing unit 250 is connected to the magnetic sensors 211, 212 and the electrodes 221˜224 and determines the concentrations of the particles and microorganisms included in the fluid using the magnetic field measured by the magnetic sensors 211, 212 and the impedance measured by the electrodes 221˜224. The signal processing unit 250 may be structured to correct the magnetic field with a magnetic field value calculated using the impedance, for example. From the impedance of the fluid, it is possible to know an amount of the charges resulting from the fluid flow, i.e., an intensity of the current and to calculate the magnetic field proportional to the intensity of the current. Comparing the calculated magnetic field with the magnetic field actually measured, it is possible to correct an error of the magnetic field actually measured or a measure error due to the noise. Here, in order to correct the magnetic field in the signal processing unit 250, it is possible to use a method of calculating an average voltage of the magnetic field value calculated using the impedance and the magnetic fields and storing the average voltage as a corrected magnetic field value. The signal processing unit 250 determines the concentrations of the particles and microorganisms included in the fluid using a proportional relation of the magnetic field and the concentrations of the particles and microorganisms. At this time, the signal processing unit 250 can use the magnetic field value corrected with the impedance. Finally, the signal processing unit 250 outputs the quantitative information that is information for the concentration of the particles or microorganisms determined.

Filters 251, 252 are connected to the magnetic sensors 211, 212 to remove the noise from the magnetic field measured by the magnetic sensors 211, 212. Likewise, filter 253 connected to the electrodes 221˜224 removes the noise from the voltage corresponding to the impedance detected by the electrodes 221˜224. The filters 251, 252 may comprise, for example a low pass filter or high pass filter so as to remove the noise.

Amplifiers 254˜256 amplify the magnetic field or voltage outputted from the filters 251˜153 and transfer it to the signal processing unit 250. The amplifiers 254˜256 may comprise, for example a differential amplifier that amplifies a voltage difference between two electrodes.

In the mean time, the magnetic field to be inputted to the filters 251˜253 and the amplifiers 254˜256 means a voltage or current signal corresponding to an intensity of the magnetic field outputted from the magnetic sensors 211, 212.

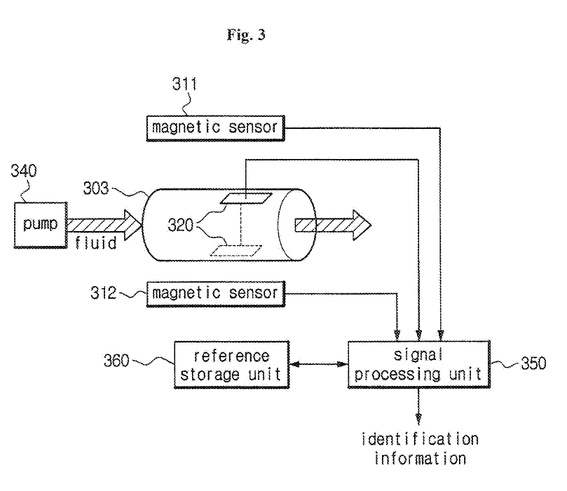

FIG. 3 shows a structure of an apparatus for detecting particles and microorganisms using a magnetic field, according to another embodiment of the invention.

Magnetic sensors 311, 312 are provided at an outside of a passage pipe 303 so as to measure a magnetic field induced when the fluid including particles or microorganisms in a predetermined concentration moves in the passage pipe 303. At this time, the fluid to be supplied into the passage pipe 303 is a fluid in which unknown particles or microorganisms are mixed in a fixed amount of solution in a predetermined concentration. The predetermined concentration can be arbitrarily determined by one skilled in the art. In FIG. 3, since the particles or microorganisms are identified, rather than quantitatively analyzed, a concentration of the fluid to be supplied need to be kept constant. In addition, when the concentration of the supplied fluid is recorded in a reference storage unit 360 or other storage devices and the reference storage unit 360 is structured to store the magnetic field values for each concentration of the fluid and each type of the particles and microorganisms, it is possible to identify the particles and microorganisms.

Electrodes 320 are provided in the passage pipe 303 so as to apply electric current having a predetermined frequency to the fluid moving in the passage pipe 303 to measure impedance. Here, the predetermined frequency can be arbitrarily determined by one skilled in the art.

A pump 340 is connected to any one inlet of the passage pipe 303 to supply the fluid in the passage pipe 303 in a predetermined rate.

A signal processing unit 350 is, connected to the magnetic sensors 311, 312 and the electrodes 320 and calculates a corrected magnetic field using the magnetic field measured by magnetic sensors 311, 312 and the impedance measured by the electrodes 320. The signal processing unit 350 searches the corrected magnetic field from the reference storage unit 360 to determine a type of the particles or microorganisms included in the fluid. The signal processing unit 350 outputs the identification information that is the information on the determined type of the particles or microorganisms.

The reference storage unit 360 stores the magnetic field values for each type of the particles and microorganisms to be included in the fluid. The reference storage unit 360 can store the magnetic field values for each type of the particles and microorganisms in a table form. The reference storage unit 360 may include, for example at least one of non-volatile memory such as flash memory and volatile memory such as SD memory that store the table.

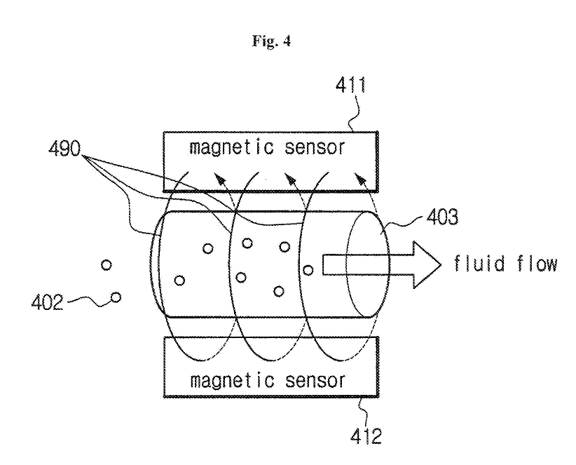

FIG. 4 shows a principle of operating an apparatus for detecting particles and microorganisms using a magnetic field, according to the invention.

As shown in FIG. 4, when the particles or microorganisms charged flow in a channel 403, a circular magnetic field 490 around the channel 403 is induced according to the Ampere's law. The magnetic sensors 411, 412 measure an intensity of the induced magnetic field. Through the intensity of the magnetic field, it is possible to quantitatively analyze and to identify the particles or microorganisms charged.

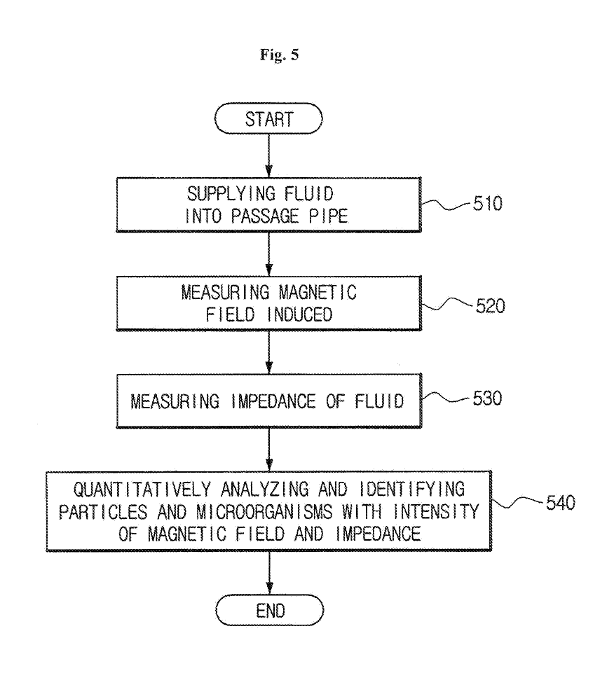

FIG. 5 is a flow chart showing a method for detecting particles and microorganisms using a magnetic field according to an embodiment of the invention.

Under state in which a magnetic field is formed at the passage pipe 203, the fluid is supplied into the passage pipe 203 with the pump (step 510).

Then, using the magnetic sensors 211, 212 provided at the outside of the passage pipe 203, the magnetic field induced by the fluid moving in the passage pipe 203 is measured (step 520).

While measuring the magnetic field induced by the fluid, the impedance of the fluid moving in the passage pipe 203 is measured with the electrodes 221˜224 provided in the passage pipe (step 530).

Finally, using the magnetic field measured by the magnetic sensors 211, 212 and the impedance measured by the electrodes 221˜224, the concentrations of the particles and microorganisms included in the fluid are determined (step 540). At this time, when the concentration of the particles or microorganisms included in the fluid to be supplied into the passage pipe 203 has been previously known, it is possible to estimate the type of the particles or microorganisms included in the fluid in accordance with the magnitude of the magnetic field measured by the magnetic sensors 211, 212. This process (step 540) may comprise a process of calculating an average magnetic field of a magnetic field value calculated using the impedance and the magnetic fields measured by the magnetic sensors 211, 212 and setting the average magnetic field as an intensity of the corrected magnetic field. That is, when quantitatively analyzing and identifying the particles and microorganisms, the induced electromotive value corrected is used.

In an embodiment the invention, the process (step 540) may comprise a process of setting an average of the voltages measured by the magnetic sensors 211, 212, which are comprised of the plural electrodes provided in the passage pipe 203 at an interval, as a magnetic filed measured by the magnetic sensors 211, 212. In other words, when quantitatively analyzing and identifying the particles and microorganisms, the average value of the magnetic fields measured by the plural magnetic sensors is used.

In an embodiment the invention, the process (step 540) may comprise a process of setting an average of the impedances measured by the electrodes 221˜224, which are comprised of the plural electrodes provided in the passage pipe 203 at an interval, as the impedance measured by the electrodes 221˜224. In other words, when quantitatively analyzing and identifying the particles and microorganisms, the average value of the impedances measured by the plural electrodes is used.

The apparatus for detecting particles and microorganisms according to an embodiment of the invention has a simpler structure, as compared to other method of sensing the microorganisms in the optical, electrical or molecular analytical manner. In addition, the apparatus can sense the microorganisms in real time, improve the measuring accuracy, and be manufactured in an ultra small scale.

The data that is analyzed with the apparatus for detecting particles and microorganisms according to an embodiment of the invention can be applied to develop a novel product or can be added to the existing product to improve the function of the product and to increase the reliability thereof. That is, the invention can be applied to an ultra small-scaled particle and microorganism detecting system kit, so that it can be used for portable or terror-prevention purposes. In addition, the invention can be applied to electric home appliances having a function of quantitatively analyzing and identifying the microorganisms included in the beverage including the water, such as water purifier, air purifier, air conditioner, robot cleaner and the like.

While the invention has been shown and described with reference to certain embodiments thereof; it will be understood by those skilled in the art that various changes in form and details may be made thereto without departing from the spirit and scope of the invention as defined by the appended claims.

What is claimed is:

1. An apparatus for detecting particles and microorganisms using a magnetic field, comprising:
a magnetic sensor that is provided at an outside of a passage pipe and measures a magnetic field induced by fluid moving in the passage pipe;
an electrode that is provided in the passage pipe so as to apply electric current having a predetermined frequency to the fluid moving in the passage pipe to measure impedance; and
a signal processing unit that uses an intensity of the magnetic field measured by the magnetic sensor and the impedance measured by the electrode to determine concentrations of particles and microorganisms included in the fluid.

2. The apparatus according to claim 1, wherein the signal processing unit uses the impedance to correct an intensity of the magnetic field measured by the magnetic sensor and uses a proportional relation of the corrected intensity of the magnetic field and the concentrations of the particles and microorganisms to determine the concentrations of particles and microorganisms included in the fluid.

3. The apparatus according to claim 2, wherein the signal processing unit calculates an average magnetic field of a magnetic field value calculated with the impedance and the magnetic field measured with the magnetic sensor and uses the average magnetic field as the corrected intensity of the magnetic field.

4. The apparatus according to claim 1, wherein the magnetic sensor comprises any one of a fluxgate magnetometer, a magneto-resistance sensor and a Hall sensor.

5. The apparatus according to claim 1, wherein a plurality of magnetic sensors provided at a distance from the passage pipe, are provided as the magnetic sensor, and the signal processing unit uses an average of magnetic fields received from the plurality of magnetic sensors as the intensity of the magnetic field measured by the magnetic sensor.

6. The apparatus according to claim 1, wherein a plurality of electrodes provided at an interval in the passage pipe are provided as the electrode, and the signal processing unit uses an average of the impedances measured by the plurality of electrodes as the impedance measured by the electrode.

7. The apparatus according to claim 1, further comprising:
a filter that is connected to the magnetic sensor and removes noise from the intensity of the magnetic field measured by the magnetic sensor; and
an amplifier that amplifies an intensity of the magnetic field outputted from the filter and transfers it to the signal processing unit.

8. The apparatus according to claim 1, further comprising a pump that is connected to any one inlet of the passage pipe and supplies the fluid into the passage pipe in a predetermined rate.

9. An apparatus for detecting particles and microorganisms using a magnetic field, comprising:
a magnetic sensor that is provided at an outside of a passage pipe and measures a magnetic field induced as fluid including any particles or microorganisms in a predetermined concentration moves in the passage pipe;
an electrode that is provided in the passage pipe so as to apply electric current having a predetermined frequency to the fluid moving in the passage pipe to measure impedance;
a reference storage unit that stores values of magnetic fields for each type of particles and microorganisms to be included in the fluid; and
a signal processing unit that is connected to the magnetic sensor and the electrode, calculates an intensity of a corrected magnetic field using an intensity of the magnetic field measured by the magnetic sensor and the impedance measured by the electrode and searches an intensity of the corrected magnetic field from the reference storage unit to determine a type of the particles or microorganisms included in the fluid.

10. The apparatus according to claim 9, further comprising:
a filter that is connected to the magnetic sensor and removes noise from the intensity of the magnetic field measured by the magnetic sensor; and
an amplifier that amplifies an intensity of the magnetic field outputted from the filter and transfers it to the signal processing unit.

11. A method for detecting particles and microorganisms with a magnetic field, comprising the steps of:
supplying fluid into a passage pipe using a pump;
measuring a magnetic field induced by the fluid moving in the passage pipe with a magnetic sensor provided at an interval from the passage pipe at an outside of the passage pipe and measuring impedance of the fluid with an electrode provided in the passage pipe; and
determining concentrations of particles and microorganisms included in the fluid using an intensity of the magnetic field measured by the magnetic sensor and the impedance measured by the electrode.

12. The method according to claim 11, wherein the step of determining the concentrations of particles and microorganisms comprises:
a step of correcting an intensity of the magnetic field measured by the magnetic sensor with a magnetic field value calculated with the impedance; and
a step of determining the concentrations of particles and microorganisms included in the fluid using a proportional relation of the corrected intensity of the magnetic field and the concentrations of particles and microorganisms.

13. The method according to claim 12, wherein the step of correcting an intensity of the magnetic field comprises;
a step of calculating an average magnetic field of the magnetic field value calculated with the impedance and the magnetic field measured with the magnetic sensor and setting the average magnetic field as the corrected intensity of the magnetic field.

14. The method according to claim 11, wherein the step of determining the concentrations of particles and microorganisms comprises:
a step of setting an average of magnetic fields measured using a plurality of magnetic sensors constituting the magnetic sensor as the intensity of the magnetic field measured by the magnetic sensor; and
a step of setting an average of impedances measured using a plurality of electrodes provided at an interval in the passage pipe as the impedance measured by the electrode.
